(19) United States
(12) Patent Application Publication
(10) Pub. No.: US 2009/0222804 A1
(43) Pub. Date: Sep. 3, 2009

(54) EMBEDDED FIRMWARE UPDATING SYSTEM AND METHOD

(75) Inventors: Charles Lyle Kaufman, Neenah, WI (US); Brandon John Speilman, Kaukauna, WI (US); Edward Gerard Beistle, Appleton, WI (US)

Correspondence Address: FLETCHER YODER (ILLINOIS TOOL WORKS INC.), P.O. BOX 692289, HOUSTON, TX, 77269-2289, US

(73) Assignee: ILLINOIS TOOL WORKS, INC., GLENVIEW, IL (US)

(21) Appl. No.: 12/040,555

(22) Filed: Feb. 29, 2008

(51) Int. Cl. B23K 9/10; G06F 9/44; G06F 12/02

(52) U.S. Cl. 717/168; 219/130.1; 711/103; 711/E12.008

(57) ABSTRACT

A system and method is described for updating firmware in a welding or plasma cutting system. A removable memory device containing updated firmware code and a set of execution instructions is interfaced with one or more component boards. The execution instructions are executed on a processor of the welding or plasma cutting system to load the updated firmware code stored on the removable memory device into memory of the welding or plasma cutting system via an interface, generally overwriting the old firmware code.

### BACKGROUND

The present invention relates generally to the field of welding systems, and more particularly to techniques for updating embedded microcontrollers on printed circuit boards used in such systems.

Welding system component boards generally include programmed control circuitry, such as an embedded microcontroller and memory, operating based on a set of embedded software instructions stored in the memory. The embedded software instructions are commonly referred to as firmware. Often, during a welding system product life cycle, subsequent firmware revisions and updates are released in order to fix software bugs in prior versions of the firmware, or to improve, introduce or enable new features for the welding system. Firmware updates and revisions may be installed as part of routine equipment maintenance and service, or when existing firmware is found to be defective. Firmware updates may also be performed in the event that a welding system becomes inoperable.

Unfortunately, existing techniques for firmware updates are time consuming, difficult/complex, and/or costly. For example, one technique for updating the firmware on component boards is by downloading the firmware updates from an internet website onto a computer or a handheld programming device, and subsequently loading the downloaded firmware updates onto the appropriate component boards via a programming cable or interface. This technique, however, is not without drawbacks. Computers and handheld programming devices are relatively expensive and require technical knowledge in order to operate effectively. As such, customers may not have the means for purchasing a computer or handheld programming device nor the knowledge to operate one with proficiency. Improperly updating firmware may result in damage not only to the component board, but also to other components of the welding system.

Moreover, to ensure proper compatibility when performing firmware updates, operating systems installed on computers and handheld programming devices may require the welding system component board to run a particular operating system, for example, Microsoft Windows CE®, sold by Microsoft Corporation. This increases the system complexity and adds to the cost of manufacturing the component boards. Furthermore, handheld programming devices may have their own component boards requiring periodic firmware updates. Often times, a handheld programming device running an outdated firmware version will interface correctly with a welding system component board prior to a firmware update, but then the firmware update renders the handheld programming device inoperable with the particular component board. Additionally, this technique requires manufacturers to create and support an internet website accessible by customers for downloading firmware revisions and updates to computers and handheld programming devices. As such, the aforementioned factors unnecessarily increase the overall production cost of welding systems.

Another technique for updating the firmware involves replacement of the entire component board. Upon receipt of a replacement component board having preinstalled firmware updates, the customer would remove the outdated component board from the welding system and then install the new updated component board. Unfortunately, customers may not have the technical knowledge to properly remove and install the component boards, and improper installation may damage the component board or possibly damage the welding system, both of which may be costly to replace or repair.

### BRIEF DESCRIPTION

Embodiments of the present invention provide a low cost system and method for updating torch systems, such as welding and plasma cutting systems. In accordance with embodiments of the present invention, the torch system includes an interface for receiving a removable memory device which may contain updated software code, such as software, device drivers, or firmware, just to name a few. Upon mating the removable memory device to the interface, the updated software code may be installed onto one or more components of the torch system.

Embodiments of the present invention may reduce the cost and labor associated with conventional torch system updating systems and methods, which may include maintaining and supporting an internet website to facilitate downloading of software updates and/or sending new preinstalled updated component boards directly to customers. Moreover, inserting a memory card is a relatively simple task and does not require a customer to have the technical expertise that may be necessary for installing a replacement component board or loading firmware updates to a welding system from a computer or handheld programming device.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of an exemplary welding system in which embedded code or instructions can be loaded, updated or overwritten via a removable memory device;

FIG. 2 is a more detailed diagrammatical overview of exemplary components for interfacing a removable memory device with a component board of the system of FIG. 1, in accordance with an embodiment of the present invention;

FIG. 3 is a similar diagrammatical overview of exemplary components for interfacing a plurality of component boards with a removable memory device for loading instructions to one or more of the boards, in accordance with an embodiment of the present invention; and

FIG. 4 is a flow chart illustrating exemplary logic for loading, updating or overwriting embedded instructions from a removable memory device to one or more component boards of a welding or plasma cutting system, in accordance with an embodiment of the present invention.

### DETAILED DESCRIPTION

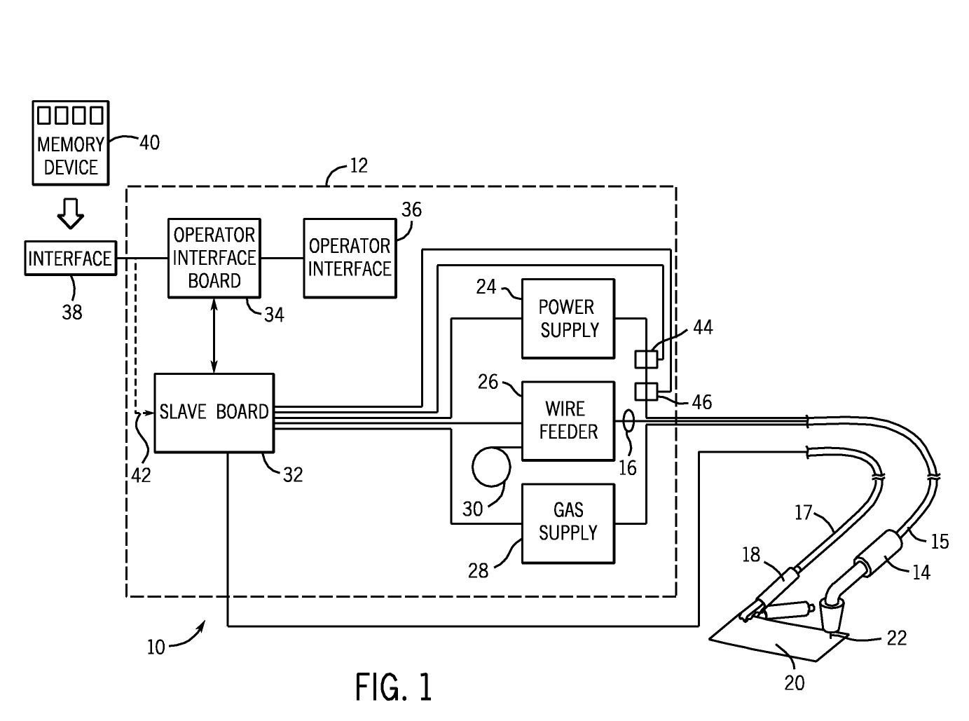

Turning now to the drawings and referring first to FIG. 1, an exemplary torch system 10 having a removable memory interface 38 for receiving a removable memory device 40 is illustrated, in accordance with an embodiment of the present invention. In one embodiment, the removable memory device 40 may contain updated embedded instructions for torch system 10, commonly referred to as firmware, although other updated instructions relating to operating system code, welding and cutting routines/parameters, device drivers, configuration files, or the like, may also be stored on the removable memory device 40. As will be discussed in further detail below, the updated firmware stored on the removable memory device 40 may be used for updating defective and/or out-of-date firmware on a system 10. Compared to conventional techniques for updating torch systems (e.g., via handheld programming devices and/or replacing component boards) embodiments of the present invention provides a simple low cost solution for updating one or more of the various software aspects on which torch systems (e.g., system 10) operate.

In the illustrated embodiment, the torch system 10 is a welding system, but other embodiments may include a cutting system, such as a plasma cutting system. In other words, any welding, cutting, or like torch system may be employed within the scope of the disclosed embodiments. Similarly, the present technique may also be applied to other industrial systems, such as induction heating systems. The following discussion refers to the system 10 as a welding system 10 as an example without limitation. Furthermore, the following discussion merely relates to exemplary embodiments of the system 10, interface 38, device 40, and so forth. As such, the appended claims should not be viewed as limited to the embodiments described herein.

The illustrated welding system 10 includes a base unit 12 operably coupled with a welding torch 14 via a conduit 15. The system also includes an electrode 16 (e.g., welding wire) fed through the conduit 15 to the torch 14, and a work cable 17 having a work clamp 18 coupled to a work piece 20. Placement of the welding torch 14 proximate to work piece 20 allows electrical current, supplied by power supply 24, to form an arc 22 from electrode 16 to the work piece 20. The arc 22 completes an electrical circuit from power supply 24 to electrode 16, to the work piece 20, then back to the welding system 10 via work clamp 18 and work cable 17. The heat produced by arc 22 causes the electrode 16 and/or work piece 20 to transition to a molten state, thereby creating the weld.

The system 10 also includes a wire feeder 26, a gas supply 28, and an electrode supply 30 (e.g., coil of welding wire). Base unit 12 supplies welding torch 14 with voltage and current from power supply 24, electrode 16 from electrode supply 30 via wire feeder 26, and shielding gas from gas supply 28 through conduit 15. The electrode 16 may be any suitable type of traditional consumable electrode. Also, in alternate embodiments, the electrode 16 may include a non-consumable electrode without the wire feeder 26 or electrode supply 30. Shielding gas from gas supply 28 shields the weld area from contaminants during welding in order to enhance arc performance and to improve the quality of the resulting weld.

In addition, the system 10 includes a controller or slave board 32, an operator interface board 34 coupled to the board 32, and an operator interface coupled to board 34. An operator may manipulate welding parameters via the operator interface 36 in order to precisely control the deposition of molten material from electrode 16 onto work piece 20. Where operator inputs are used, these may be provided by digital devices, analog circuits (i.e., dials with associated potentiometers), and so forth. The processed operator inputs are communicated to slave board 32. Slave board 32 is operably coupled to and is configured to control the power supply 24, wire feeder 26, and gas supply 28 based on the operator inputs received. For example, slave board 32 may be configured to adjust the power output from power supply 24 based on operator inputs while monitoring supply voltage and current with voltage sensor 44 and current sensor 46. Slave board 32 may also be configured to regulate the advancement of electrode 16 via wire feeder 26, as well as the shielding gas output from gas supply 28 based on the operator inputs.

Operator interface board 34 and slave controller board 32 may include any suitable control circuitry and may be based upon a general purpose or application-specific microprocessor or microcontroller or other programmed control circuitry. Although not represented in FIG. 1, the controller is, of course, supported by ancillary devices and circuitry, such as power supplies, memory devices, signal conditioning circuitry, and so forth.

Removable memory interface 38 is operably coupled to operator interface board 34 and is configured to transmit data from removable memory device 40 to one or more component boards of the welding system 10. As illustrated in FIG. 1, removable memory interface 38 may be coupled to a single component board (e.g., operator interface board 34), or multiple component boards (e.g., boards 34 and 36), as indicated by dashed line 42. In one embodiment of the invention, the removable memory interface 38 may be located external to the welding system 10. For example, the removable memory interface 38 may be mounted on the housing of the welding system 10. In alternate embodiments, the removable memory interface 38 may also be located internal to the welding system 10, such that a user may be required to remove one or more panels or coverings to access the interface 38.

As discussed above, embodiments of the present invention provide a simple low cost solution for updating torch systems, such as the presently illustrated welding system 10. Accordingly, embodiments of the removable memory device 40 may include any one of available low cost and/or portable memory devices, as will be discussed in further detail below. That is, embodiments of the removable memory device 40 are simply a memory/storage device containing updated software code (e.g., firmware) without a handheld device, processor, or other electronic components. Therefore, the updating of the welding system 10 via the removable memory interface 38 and the removable memory device 40 not only eliminates the need for downloading updates onto handheld programming devices or replacing components, but also further eliminates potential software version conflicts between the welding system 10 and conventional handheld programming devices.

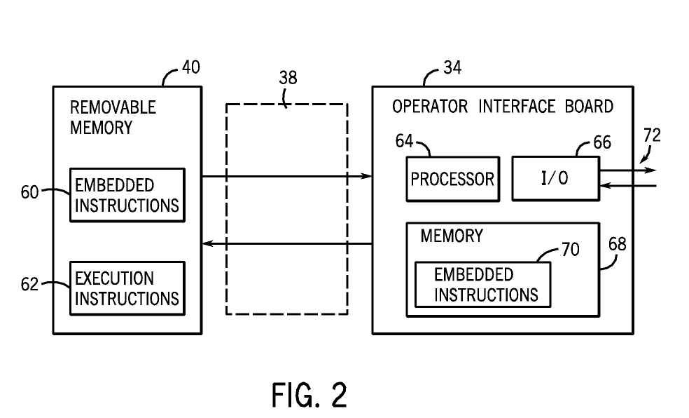

FIG. 2 illustrates a detailed diagrammatical overview of exemplary components for interfacing removable memory device 40 with the operator interface component board 34 of welding system 10 of FIG. 1 in accordance with an embodiment of the present invention. Removable memory device 40 communicates with operator interface board 34 through removable memory interface 38. For example, the removable memory device 40 may mate directly with the interface 38 without a cable.

Removable memory device 40 stores both updated firmware code 60 to replace outdated or defective firmware code 70 stored in memory 68 on operator interface board 34, as well as a set of execution instructions 62 for loading, updating, or overwriting the outdated or defective firmware 70. That is, the removable memory device 40 consists essentially of memory and an update stored thereon. Moreover, in contrast to conventional handheld programming devices, embodiments of the removable memory device 40 generally exclude a display, a processor, a battery, a network connection, or the like. In other words, embodiments of the removable memory device 40 may simply be low cost, portable memory devices containing the appropriate update 60 and/or execution instructions 62. In one embodiment, the removable memory device 40 may have a form factor of less than 10 cubic inches. For example, the removable memory device 40 may include a portable external hard disk drive. In another embodiment, the removable memory device 40 may have a form factor of less than 3 cubic inches. For example, the removable memory device 40 may include a universal serial bus (“USB”) drive, a data-flash card, a multimedia card, a Secure Digital card, a Compact Flash card, a Micro Secure Digital card, a Mini Secure Digital card, a Smart Media card, a Memory Stick Pro Duo card, or any other type of portable compact memory.

For purposes of clarity and explanation, removable memory interface 38 is illustrated by a single input arrow and a single output arrow between removable memory device 40 and operator interface component board 34. However, a number of interfaces may be used for interfacing removable memory device 40 to a component board. That is, removable memory interface 38 may include any type of suitable interface, including a USB interface, a serial advanced technology attachment (SATA) interface, a IEEE 1394 (FireWire) interface, a serial peripheral interface (SPI), a universal synchronous and asynchronous interface (USART), a controller area network (CAN), as well as any other interface supporting the above discussed removable memories, just to name a few.

As discussed above, operator interface component board 34 may be based upon programmed control circuitry, such as a microcontroller, represented generally by processor 64, input/output circuitry 66, and memory 68. The operator interface component board 34 receives operator inputs from operator interface 36 via input/output circuitry 66, operating based on firmware code 70 stored in memory 68.

The execution instructions 62 stored on removable memory device 40 may be performed by processor 64 and may be initiated by a user (e.g., via operator interface 36) upon inserting removable memory device 40 into removable memory interface 38 while welding system 10 is powered. The execution instructions 62 may initiate loading of the updated firmware code 60 to memory 68 of operator interface component board 34. For example, the execution instructions 62 may be configured to send the updated firmware code 60 to the operator interface component board 34 via removable memory interface 38 and store the updated firmware code 60 to an address in memory 68. In one embodiment, the current firmware code 70 may be overwritten by the updated firmware code 60.

In certain embodiments, the execution instructions 62 may be further configured to first determine whether or not a component board 34 may require a firmware update before initiating the update procedures. Alternatively, the component board 34 may include decision logic configured to compare the firmware 60 (e.g., version check) on the removable memory device 40 to the firmware 70 currently stored in component board memory 68 to determine if a firmware update is desirable. After the update is complete, the operator interface component board 34 operates based on the updated firmware code 60. In some embodiments, removable memory device 40 may include only the updated firmware code 60, and not include execution instructions 62. Such embodiments may passively rely on instructions stored on the recipient system (e.g., welding system 10) or on one or more component boards (e.g., boards 32 and 34) to perform all the necessary execution and processing steps to install the updated firmware code stored on removable memory device 10 into the welding system 10. Certain embodiments may also utilize plug-and-play technologies, such that the updated firmware code 60 may be automatically installed by the system 10 upon detecting the insertion of removable memory device 40 into removable memory interface 38. Further, certain embodiments may provide the user with verification that an update has been successfully installed (e.g., via the operator interface 36).

In certain embodiments, security features may be implemented so that the removable memory device 40 will permit only a one time update and/or limit updating to only authorized welding systems. For example, when execution instructions 62 are executed, a bit may be set in removable memory device 40 to prevent the execution instructions 62 from being re-executed subsequently on another welding system. Alternatively, the execution instructions 62 may be protected by a unique password or personal identification number (PIN) which must be entered by a user, such as via a keypad on operator interface 36, prior to allowing execution and updating. Furthermore, the execution instructions 62 may be configured to check and compare a welding system's serial number with a list of authorized serial numbers to verify that the welding system is authenticated to receive the updated firmware code 60. In another embodiment, authentication may be provided by one or more security keys. For example, the system 10 may include a unique or shared key, whereas the removable memory device 40 includes a key that permits removable memory device 40 to work only with a system 10 having an authorized key. Further, some embodiments may include a combination of the above described security features for providing additional levels of security.

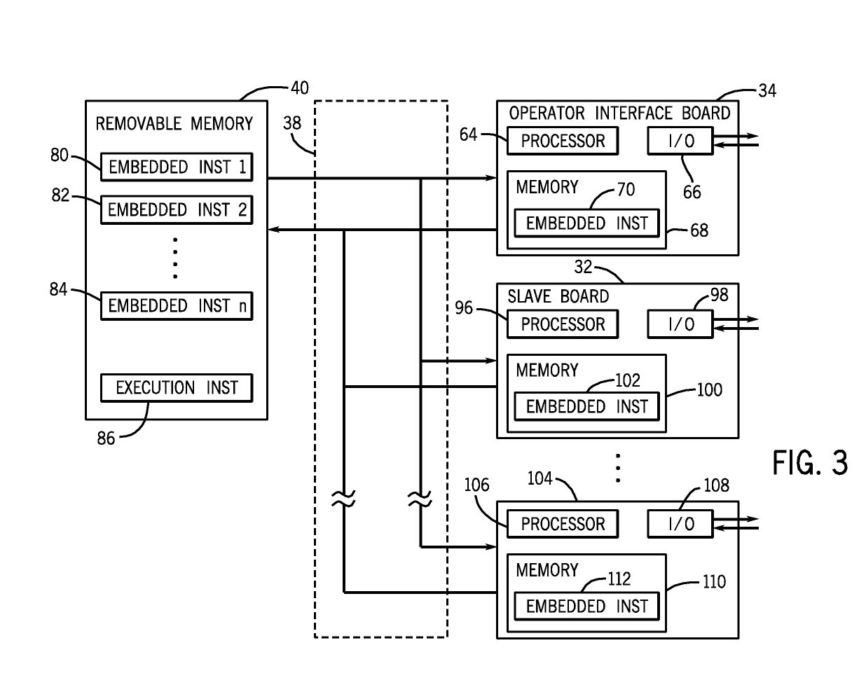

In FIG. 3, removable memory interface 38 of FIG. 2 has been modified to interface removable memory device 40 with a plurality of component boards 32, 34, and 104 in welding system 10. As discussed above, removable memory interface 38 includes input and output communication lines to the operator interface component board 34. As shown in FIG. 3, removable memory interface 38 has been further modified to include additional input and output communication lines to slave controller component board 32 and additional component board 104. Like the operator interface component board 34, the slave controller component board 32 and the additional component board 104 are based upon programmed control circuitry, such as a microcontroller, represented respectively by processors 96 and 106, input/output circuitry 98 and 108, and memory 100 and 110.

Removable memory device 40, as shown in FIG. 3, includes multiple sets of updated firmware code 80, 82 and 84, each respectively corresponding to the operator interface component board 34, the slave controller component board 32, and the additional component board 104. If removable memory device 40 is inserted in removable memory interface 38 when welding system 10 is powered on, execution instructions 86 may be executed by processors 64, 96, and 106 to initiate loading of updated firmware code 80, 82 and 84 respectively to memory 68 of operator interface component board 34, memory 100 of slave controller component board 32, and memory 110 of additional component board 104. The execution instructions 86 may be configured to send the updated firmware code 80, 82 and 84 to the component boards 32, 34 and 104 via the removable memory interface 38, and store the updated firmware code 80, 82, and 84 respectively to addresses in memory 68, 100 and 112. In some embodiments, the execution instructions 86 may be configured to first determine whether or not component boards 32, 34, and 104 may require firmware updates before initiating the update procedures. Alternatively, component boards 32, 34, and 104 may include decision logic configured to compare the firmware code 80, 82, and 84 on the removable memory device 40 respectively to firmware code 70, 102, and 112, currently stored respectively in component board memory 68, 100, and 110, to determine if firmware updates are desirable. As such, the outdated or defective firmware code 70, 102 and 112 may be overwritten. Furthermore, the removable memory device 40 of FIG. 3 may also include similar security features, as discussed above with reference to FIG. 2.

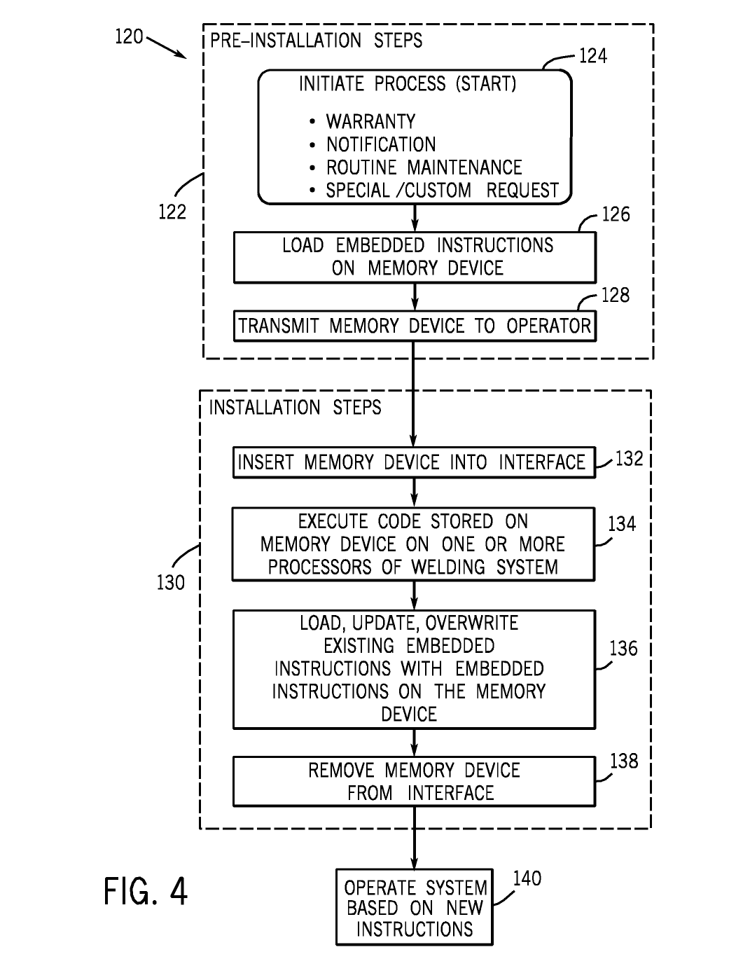

FIG. 4 illustrates a process 120 of updating firmware for a welding system, in accordance with embodiments of the present invention. As illustrated, the process 120 may be divided into a pre-installation process (block 122) and an installation process (block 130). A request or need for a firmware update at block 124 may initiate the pre-installation process 122. By way of example, the request may arise from a warranty claim filed by a customer due to a malfunctioning welding system, routine maintenance by a service technician, or notification to customers that a firmware update is currently available. The request may also be initiated if a customer makes a request for a specific and/or custom firmware package. Once a request from block 124 is processed, appropriate firmware updates may be loaded onto a removable memory device at block 126. At the conclusion of the pre-installation process 122, the removable memory device may be transmitted (e.g., via mail or via courier) to the operator of the welding system, as denoted by block 128.

The installation process 130 may be initiated once an operator, having received the removable memory device, inserts the removable memory device into the removable memory interface, as shown at block 132. At block 134, execution instructions stored on the removable memory device may be executed by a processor on one or more welding system component boards to initiate loading of the updated firmware code into the memory of the one or more component boards. As discussed above, the execution code may also initiate security checks, such as authenticating the receiving system prior to updating the firmware. At block 136, the updated firmware code may be loaded from the removable memory device into memory on one or more target component boards in the welding system 10. The current firmware stored in the component board memory may be overwritten by the updated firmware. Once the update is complete, an operator may remove the memory device from the interface, ending the installation process 130 at block 138. The welding system and its various component boards may now operate based on the newly installed firmware, as shown by block 140.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A torch system, comprising:
a removable memory device consisting essentially of memory, an interface coupled to the memory, an update stored on the memory, and installation instructions stored on the memory, wherein the installation instructions are executable to install the update onto the torch system when the interface is coupled to a mating interface at the torch system.

2. The torch system of claim 1, wherein the removable memory device has a compact form factor of less than 10 cubic inches.

3. The torch system of claim 1, wherein the memory comprises flash memory.

4. The torch system of claim 1, wherein the update comprises a firmware update for the torch system.

5. The torch system of claim 1, wherein the update comprises a torch welding update, a torch cutting update, or a combination thereof.

6. The torch system of claim 1, wherein the installation instructions comprise auto install code configured to install the update onto the torch system.

7. The torch system of claim 1, wherein the installation instructions are executable by the torch system rather than the removable memory device.

8. The torch system of claim 1, wherein the installation instructions are protected by at least one means of secured authentication.

9. A torch system, comprising:
a torch power unit, comprising:
a power supply;
a controller coupled to the power supply;
a memory disposed on the controller;
a firmware stored on the memory; and
an interface configured to receive a removable memory device to update the firmware stored on the memory without a portable computing device and without a remote network connection to the torch power unit.

10. The torch system of claim 9, wherein the controller is configured to execute installation instructions to install a firmware update onto the memory.

11. The torch system of claim 9, wherein the firmware comprises instructions relating to operation of welding, cutting, wire feeding, shielding gas flow, or a combination thereof.

12. The torch system of claim 9, wherein the interface is disposed directly on a housing and/or a control panel of the torch power unit.

13. The torch system of claim 9, wherein the interface comprises a memory slot configured to receive the removable memory device.

14. The torch system of claim 13, wherein the memory slot comprises a flash memory slot.

15. The torch system of claim 9, wherein the interface comprises a communication connector configured to support the removable memory device in a cantilevered manner relative to the torch power unit.

16. The torch system of claim 15, wherein the communication connector comprises a universal serial bus (USB) interface.

17. The torch system of claim 15, wherein the communication connector comprises a FireWire or IEEE 1394 interface.

18. A component of a torch system, comprising:
a controller;
a memory disposed on the controller;
a firmware stored on the memory; and
an interface configured to receive a removable memory device to update the firmware stored on the memory without a portable computing device and without a remote network connection to the component and the torch system.

19. The component of claim 18, wherein the component comprises a wire feeder.

20. The component of claim 18, wherein the component comprises a welding unit.

21. The component of claim 18, wherein the component comprises a plasma cutting unit.

22. A method, comprising:
interfacing a removable memory device with a torch system without a remote network interface and without a portable computing device, wherein the removable memory device comprises memory and an update stored on the memory; and
installing the update into the torch system to update the instructions.

23. The method of claim 22, wherein interfacing comprises supporting the removable memory device in a cantilevered position relative to the torch system.

24. The method of claim 22, wherein interfacing comprises receiving the removable memory device in a memory slot on the torch system.

25. The method of claim 22, wherein installing the update comprises executing installation instructions stored on the memory in a processor of the torch system.
